(19) United States
(12) Patent Application Publication
(10) Pub. No.: US 2011/0170212 A1
(43) Pub. Date: Jul. 14, 2011

(54) METHOD AND APPARATUS FOR PREVENTING DATA LOSS IN HARD DISK DRIVE

(75) Inventors: Young-Shil CHOI, Suwon-si (KR); Jin Wan JUN, Seoul (KR)

(73) Assignee: SAMSUNG ELECTRONICS CO., LTD., Suwon-si (KR)

(21) Appl. No.: 12/983,997

(22) Filed: Jan. 4, 2011

(30) Foreign Application Priority Data
Jan. 14, 2010 (KR) 10-2010-0003538

(51) Int. Cl. G11B 27/36

(52) U.S. Cl. 360/31; G9B/27.052

(57) ABSTRACT

A method of preventing data loss in a hard disk drive comprises detecting a write error, performing a write retry operation upon detection of the write error, and storing write retry information in a non-volatile memory before performing the write retry operation. The write retry information comprises location information and data for a sector to be rewritten in the write retry operation.

### CROSS-REFERENCE TO RELATED APPLICATIONS

This application claims priority under 35 U.S.C. §119 to Korean Patent Application No. 10-2010-0003538 filed on Jan. 14, 2010, the disclosure of which is hereby incorporated by reference in its entirety.

### BACKGROUND

Embodiments of the inventive concept relate generally to electronic data storage technologies. More particularly, embodiments of the inventive concept relate to hard disk drives and methods of preventing data loss in hard disk drives during unexpected power outages.

A hard disk drive performs a write operation to store data in a sector of a magnetic storage medium. Where the write operation is unsuccessful, the hard disk drive performs a write retry operation. In the write retry operation, the hard disk drive makes a further attempt to store the data in the sector. However, where the hard disk drive unexpectedly loses power during the write retry operation, the data can be lost.

### SUMMARY

Embodiments of the inventive concept provide methods and apparatuses for preventing data loss in a hard disk drive when a power outage occurs during a write retry operation.

According to one embodiment of the inventive concept, a method of preventing data loss in a hard disk drive comprises detecting a write error in the hard disk drive, performing a write retry operation in response to the detected write error, and storing write retry information in a non-volatile memory, the write retry information comprising a location of a disk sector where the write retry operation is to be performed, and data to be stored in the disk sector in the write retry operation.

In certain embodiments, the method further comprises, in response to a power on operation of the hard disk drive, reading the location and the data from the non-volatile memory and writing the data in the disk sector.

In certain embodiments, the method further comprises, in response to the power on operation of the hard disk drive, determining a total number of sectors for which write retry information is stored in the non-volatile memory.

In certain embodiments, the method further comprises determining a total number of sectors for which write retry information is stored in the non-volatile memory, comparing the total number of sectors with a maximum number of sectors for which write retry information can be stored in the non-volatile memory, and upon determining that the total number of sectors is less than the maximum number of sectors, storing the write retry information in the non-volatile memory.

In certain embodiments, the method further comprises incrementing the total number of sectors upon storing the write retry information in the non-volatile memory, and decrementing the total number of sectors upon successfully completing a write retry operation.

In certain embodiments, the method further comprises, in response to a power on operation of the hard disk drive, accessing a flag stored in the non-volatile memory to determine whether the nonvolatile memory stores any write retry information.

In certain embodiments, the method further comprises setting the flag to a logical “1” upon storing write retry information in the non-volatile memory.

In certain embodiments, the non-volatile memory comprises a flash memory device.

According to another embodiment of the inventive concept, a hard disk drive comprises a magnetic recording medium configured to store data, a spindle motor configured to rotate the magnetic recording medium, a head configured to write the data in the magnetic recording medium or read the data from the magnetic recording medium, a pre-amplifier configured to amplify a write signal to write the data or to amplify a read signal output from the head, and a processor. The processor is configured to detect a write error based on the read signal, perform a write retry operation upon detecting the write error, and store write retry information in a non-volatile memory before performing the write retry operation, wherein the write retry information comprises a location of a disk sector where the write retry operation is to be performed, and data to be written in the sector during the write retry operation.

In certain embodiments, the processor reads the write retry information from the non-volatile memory in response to a power on operation of the hard disk drive, and thereafter writes the data in the disk sector.

In certain embodiments, in response to a power on operation of the hard disk drive, the processor determines a total number of sectors for which write retry information is stored in the non-volatile memory.

In certain embodiments, the processor compares a total number of sectors for which write retry information is stored in the non-volatile memory with a maximum number of sectors for which write retry information can be stored in the non-volatile memory, determines whether the total number is greater than the maximum number, and upon determining that the total number of sectors is not greater than the maximum number of sectors, stores the write retry information in the non-volatile memory.

In certain embodiments, the processor increments the total number of sectors upon storing the write retry information in the non-volatile memory.

In certain embodiments, the processor decrements the total number of sectors upon successfully completing a write retry operation.

In certain embodiments, the nonvolatile memory comprises a flash memory.

According to one embodiment of the inventive concept, a computer system comprises a hard disk drive, and a host processor configured to exchange data with the hard disk drive. The hard disk drive comprises a magnetic recording medium configured to store data, a spindle motor configured to rotate the magnetic recording medium, a head configured to write the data in the magnetic recording medium or read the data from the magnetic recording medium, a pre-amplifier configured to amplify a write signal to write the data or to amplify a read signal output from the head, and a processor configured to detect a write error based on the read signal, perform a write retry operation upon detecting the write error, and store write retry information in a non-volatile memory before performing the write retry operation, wherein the write retry information comprises a location of a disk sector where the write retry operation is to be performed, and data to be written in the sector during the write retry operation.

In certain embodiments, the processor reads the write retry information from the non-volatile memory in response to a power on operation of the hard disk drive, and thereafter writes the data in the disk sector.

In certain embodiments, in response to a power on operation of the hard disk drive, the processor determines a total number of sectors for which write retry information is stored in the non-volatile memory.

In certain embodiments, the processor compares a total number of sectors for which write retry information is stored in the non-volatile memory with a maximum number of sectors for which write retry information can be stored in the non-volatile memory, determines whether the total number is greater than the maximum number, and upon determining that the total number of sectors is not greater than the maximum number of sectors, stores the write retry information in the non-volatile memory.

In certain embodiments, the computer system further comprises a wireless communication interface for wireless communication with an external computer system.

### BRIEF DESCRIPTION OF THE DRAWINGS

The drawings illustrate selected embodiments of the inventive concept. In the drawings, like reference numbers indicate like features.

FIG. 1 is a block diagram of a hard disk drive according to an embodiment of the inventive concept.

FIG. 2 is a flowchart illustrating a data back-up operation performed in a write retry operation of a hard disk drive according to an embodiment of the inventive concept.

FIG. 3 is a flowchart illustrating a data recovery operation performed when a hard disk drive is powered ON according to an embodiment of the inventive concept.

FIG. 4 is a block diagram of a computer system comprising a hard disk drive according to an embodiment of the inventive concept.

### DETAILED DESCRIPTION OF EMBODIMENTS

Embodiments of the inventive concept are described below with reference to the accompanying drawings. These embodiments are presented as teaching examples and should not be construed to limit the scope of the inventive concept.

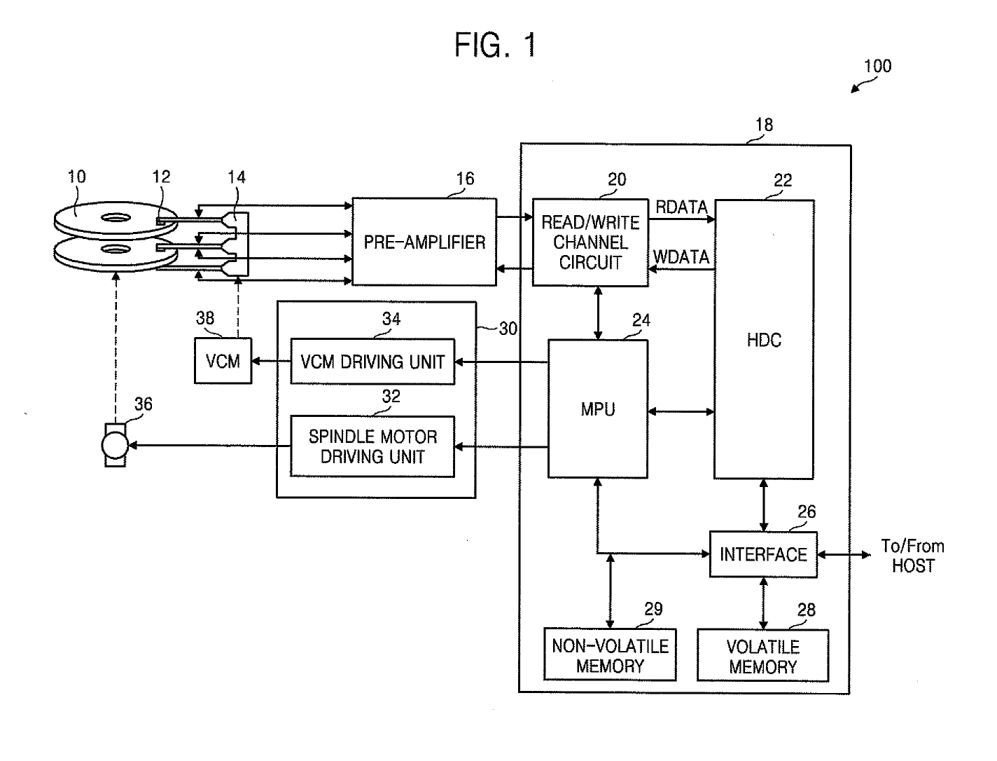

FIG. 1 is a block diagram of a hard disk drive (HDD) 100 according to an embodiment of the inventive concept. Referring to FIG. 1, HDD 100 comprises a plurality of magnetic storage media 10, a plurality of heads 12, a head assembly 14, a pre-amplifier 16, a circuit block 18, a motor control block 30, a spindle motor 36 and a voice coil motor (VCM) 38. Circuit block 18 comprises a read/write channel circuit 20, a hard disk controller (HDC) 20, a microprocessor unit (MPU) 24, an interface 26, a volatile memory 28 and a non-volatile memory 29. Motor control block 30 comprises a spindle motor driving unit 32 and a VCM driving unit 34.

Each of the magnetic storage media 10 stores data and is rotated by spindle motor 36. Each of the plurality of magnetic storage media 10 is called a disk. Each of heads 12 performs read or write operations on a corresponding one of the plurality of magnetic storage media 10. Heads 12 are installed on corresponding support arms that extend from head assembly 14. Head assembly 14 is moved by VCM 38 to sense different locations on magnetic storage media 10.

In a read operation of HDD 100, one of heads 12 senses data stored in magnetic storage media 10 to generate a read signal. Pre-amplifier 16 amplifies the read signal and outputs an amplified read signal to read/write channel circuit 20. In a write operation of HDD 100, pre-amplifier 16 transmits a write signal, e.g., a write current, output from read/write channel circuit 20 to one of heads 12. The one of heads 12 writes data on one of the plurality of magnetic storage media 10 according to the write signal.

Read/write channel circuit 20 converts a read signal amplified by pre-amplifier 16 into read data and outputs the read data to hard disk controller HDC 22. Read/write channel circuit 20 also converts write data WDATA output from HDC 22 into a write signal and outputs the write signal to pre-amplifier 16. In some embodiments, read/write channel circuit 20 transmits servo information to MPU 24 in response to a servo gate signal output from MPU 24.

In a write operation of HDD 100, HDC 22 outputs write data WDATA received from a host to read/write channel circuit 20 under the control of MPU 24. Write data WDATA is then written in one of magnetic recording media 10 through read/write channel circuit 20, pre-amplifier 16, and one of heads 12. In a read operation of HDD 100, HDC 22 receives read data RDATA decoded by read/write channel circuit 20 and transmits the decoded read data to the host through an interface 26 under the control of MPU 24.

MPU 24 controls the operation of HDC 22, such as the performance of read and write operations. MPU 24 receives read commands or write commands transmitted from the host to interface 26 and controls spindle motor driving unit 32 and VCM driving unit 34 to control track seek or track following in accordance with the received commands.

Spindle motor driving unit 32 controls the operation of spindle motor 36 by controlling the rotation of magnetic recording media 10 in response to control signals output from MPU 24. VCM driving unit 34 generates and outputs a driving current for driving VCM 38 to a voice coil of VCM 38 in response to a control signal output from MPU 24, and controls the respective locations of heads 12.

VCM 38 moves the plurality of heads 12 onto a track of magnetic recording media 10 according to the driving current output from VCM driving unit 34. The head 12 moved by VCM 38 outputs location information recorded on a disk 10 based on a control signal output from read/write channel circuit 20, to pre-amplifier 16.

Where the head 12 is moved to a target track to read information from one of magnetic recording media 10, MPU 24 outputs a servo gate signal to read/write channel circuit 20. Read/write channel circuit 20 reads a servo pattern recorded in magnetic recording medium 10 in response to the servo gate signal.

Volatile memory 28 stores read data or write data output from interface 28. Volatile memory 28 can comprise, for instance, a dynamic random access memory (DRAM) or a static random access memory (SRAM).

Non-volatile memory 29 stores firmware or program code for controlling the operation of HDD 100. In addition, non-volatile memory 29 stores program for performing a write retry operation. Non-volatile memory 29 can comprise, for example, a read only memory (ROM), a programmable read only memory (PROM), an erasable programmable read only memory (EPROM), an electrically erasable programmable read only memory (EEPROM), a flash memory, a ferroelectrics random access memory (FRAM), a magnetic random access memory (MRAM), a phase change random access memory (PRAM), a nano random access memory (NRAM), a silicon-oxide nitride-oxide-silicon (SONOS), a resistive random access memory (RRAM), or a racetrack memory.

In some embodiments, circuit block 18 comprises a single chip, such as a system on chip (SoC). In some embodiments, motor control block 30 comprises a single chip.

MPU 24 controls HDC 22 to perform a write retry operation upon detection of a write error. MPU 24 stores in non-volatile memory 29 location information and data of a sector where a write retry operation is to be performed. By storing the location information and data in non-volatile memory 29, data loss is prevented from occurring where HDD 100 loses power during the write retry operation.

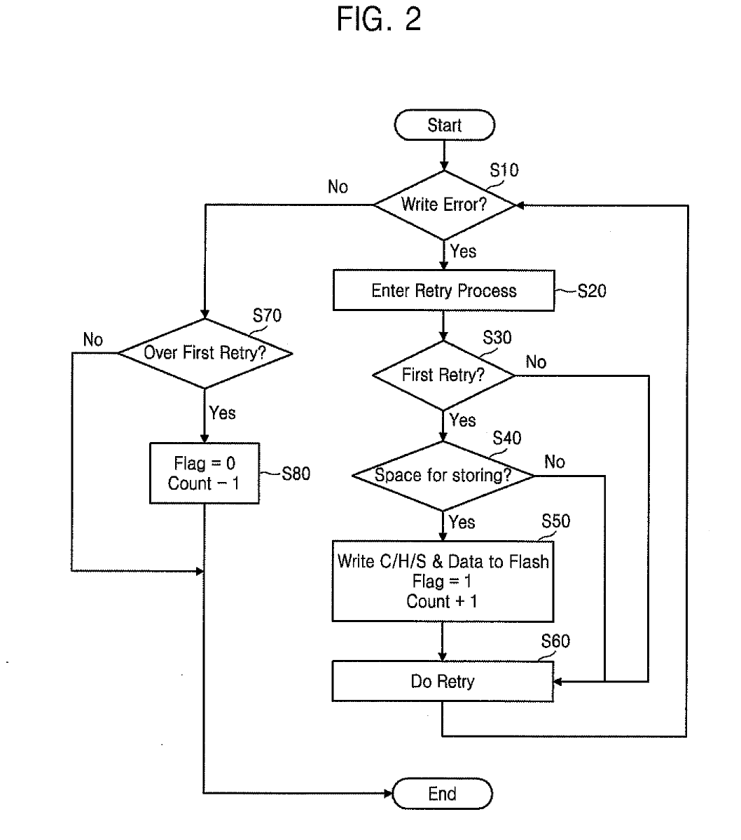

FIG. 2 is a flowchart illustrating a data back-up operation performed during a write retry operation of a hard disk drive according to an embodiment of the inventive concept. The method of FIG. 2 is explained with reference to HDD 100 of FIG. 1. In the description that follows, example method steps are indicated by parentheses to distinguish them from example apparatus elements.

Referring to FIGS. 1 and 2, MPU 24 detects a write error based on a read signal output from one of heads 12 (S10). In response to the write error (S10=Yes), MPU 24 initiates a write retry operation (S20). In a first retry operation of the write retry operation (S30=Yes), MPU 24 determines whether non-volatile memory 29 has space to store data for a sector to be retried (S40). In retry operations other than the first retry operation (S30=No), the method continues to operation S60.

Where the total number of sectors stored in non-volatile memory 29 is less than a maximum number of sectors that can be stored (S40=Yes), MPU 24 stores in non-volatile memory 29 location information of a sector to be retried and data to be stored in the location of the sector (S50). The sector comprises location of a sector to be retried and data to be stored in the location of the sector. Where the total number of sectors stored in non-volatile memory 29 is not less than a maximum number of sectors that can be stored (S40=No), the method continues to operation S60.

The location information and the data of the sector are typically stored in a spare area of non-volatile memory 29 where a firmware or a program code is stored. The location information of the sector is stored in a first storage region of non-volatile memory 29, such as a header part, and the data is stored in a second storage region of non-volatile memory 29, such as a data part. The location information of the sector typically comprises a cylinder, a head, a sector number of a sector where data is to be written, and a flag indicating whether or not the data is backed up.

In addition, MPU 24 controls activation of the flag, where the activation indicates that non-volatile memory 29 stores a sector to be retried. For example, MPU 24 can set the flag to 1, and MPU 24 can add 1 to the total number of sector stored in non-volatile memory 29.

MPU 24 controls read/write channel circuit 20 to perform a write retry operation (S60). The write retry operation is iteratively executed until no write error occurs or the number of write retries reaches a predetermined threshold. Where no write error is detected (510=No), MPU 24 determines whether or not the write retry number is more than a first retry (S70).

Where the write retry number is greater than or equal to a first retry (S70=Yes), MPU 24 controls inactivation of the flag (S80). For example, MPU 24 may set the flag to 0. Here, MPU 24 subtracts 1 from the total number of sector stored in non-volatile memory 29.

As indicated by the foregoing, in some embodiments, a write error is detected by read/write channel circuit 20, HDC 22, or MPU 24, and a write retry method is performed by MPU 24 or HDC 22 under a control of MPU 24.

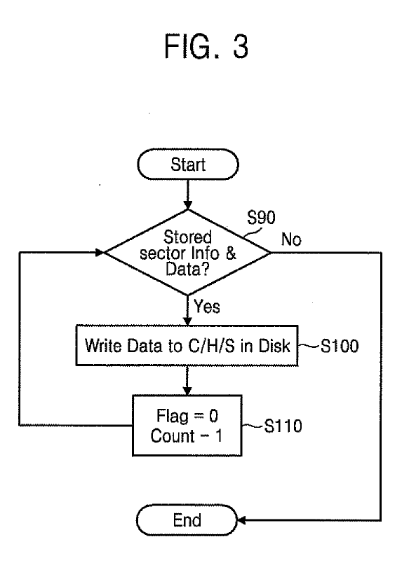

FIG. 3 is a flowchart illustrating a data recovery operation performed after HDD 100 is powered ON according to an embodiment of the inventive concept.

Where HDD 100 is powered ON, MPU 24 or HDC 22 determines a total number of sectors stored in non-volatile memory 29 (S90). Each stored sector comprises a location of a sector to be retried and data to be stored at the location. In certain embodiments, the sector comprises data of sizes 512 Bytes, 1024 Bytes, 2048 Bytes, or other multiples of 512 Bytes.

Where non-volatile memory 29 stores at least one sector to be retried (S90=Yes), e.g., where the total number of sectors to be retried and stored in non-volatile memory 29 is greater than 0, HDC 22 or MPU 24 reads the location information and the data of the at least one sector from non-volatile memory 29. MPU 24 then writes the read data on a disk 10 corresponding to the location information of the read sector (S100).

HDC 22 or MPU 24 then controls inactivation of a flag, and the inactivation indicates that a write retry operation has been completed on a sector (S110). For example, HDC 22 or MPU 24 can set the flag to 0. In addition HDC 22 or MPU 24 subtracts 1 from the total number of sectors stored in non-volatile memory 29 (S110).

Where there is no sector stored in non-volatile memory 29 and to be retried (S90=No), e.g., the number of sector stored in non-volatile memory 29 and to be retried is 0, the data recovery operation is terminated when a power of hard disk drive 100 is ON.

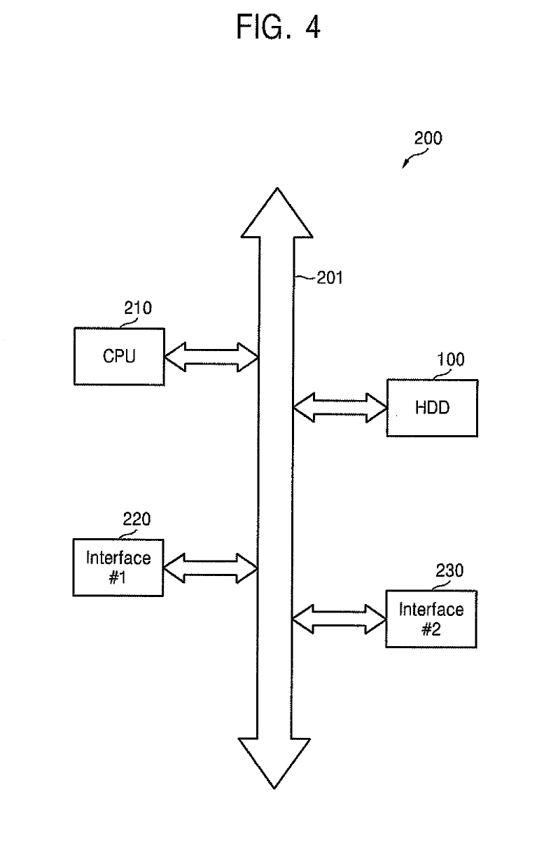

FIG. 4 is a block diagram of a computer system 200 comprising a hard disk drive according to an embodiment of the inventive concept. Computer system 200 can comprise, for instance, a personal computer, a portable computer, a handheld communication device, a digital TV, or a home automation device.

Computer system 200 comprises HDD 100 and a CPU 210 coupled to each other through a system bus 201. HDD 100 and CPU 210 communicate with each other according to a SATA communication protocol. CPU 210 may control a general operation of HDD 100, e.g., a write operation or a read operation. HDD 100 stores location information and data of a sector to be retried in non-volatile memory 29 where a first retry operation of write retry is performed according to any of the methods described with respect to FIGS. 1 through 3.

Computer system 200 further comprises a first interface 220, which can act as an input/output interface. The input/output interface can be an output device such as a monitor or a printer, or an input device such as a mouse or a keyboard.

Computer system 200 further comprises a second interface 230, which can be a wireless communication interface for a wireless communication with an external computer system. Accordingly, second interface 230 can transmit data stored in HDD 100 to an external computer system by radio or transmit data transmitted to the external computer system to HDD 100 under a control of CPU 210. Where computer system 200 comprises a hybrid HDD, computer system 200 can further comprise a non-volatile memory device. CPU 210 can store data in HDD 100 or the non-volatile memory device according to a data storage policy.

As indicated by the foregoing, a method and apparatus for preventing data loss store, in a non-volatile memory, location and data of a sector to be retried during a first retry operation of any write retry operation. Accordingly, even where power is lost during a retry operation, data of a sector to be retried is preserved.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims.

What is claimed is:

1. A method of preventing data loss in a hard disk drive, comprising:
detecting a write error in the hard disk drive;
performing a write retry operation in response to the detected write error; and
storing write retry information in a non-volatile memory, the write retry information comprising a location of a disk sector where the write retry operation is to be performed, and data to be stored in the disk sector in the write retry operation.

2. The method of claim 1, further comprising:
in response to a power on operation of the hard disk drive, reading the location and the data from the non-volatile memory and writing the data in the disk sector.

3. The method of claim 2, further comprising:
in response to the power on operation of the hard disk drive, determining a total number of sectors for which write retry information is stored in the non-volatile memory.

4. The method of claim 1, further comprising:
determining a total number of sectors for which write retry information is stored in the non-volatile memory;
comparing the total number of sectors with a maximum number of sectors for which write retry information can be stored in the non-volatile memory; and
upon determining that the total number of sectors is less than the maximum number of sectors, storing the write retry information in the non-volatile memory.

5. The method of claim 4, further comprising:
incrementing the total number of sectors upon storing the write retry information in the non-volatile memory; and
decrementing the total number of sectors upon successfully completing a write retry operation.

6. The method of claim 1, further comprising:
in response to a power on operation of the hard disk drive, accessing a flag stored in the non-volatile memory to determine whether the nonvolatile memory stores any write retry information.

7. The method of claim 6, further comprising:
setting the flag to a logical “1” upon storing write retry information in the non-volatile memory.

8. The method of claim 1, wherein the non-volatile memory comprises a flash memory device.

9. A hard disk drive comprising:
a magnetic recording medium configured to store data;
a spindle motor configured to rotate the magnetic recording medium;
a head configured to write the data in the magnetic recording medium or read the data from the magnetic recording medium;
a pre-amplifier configured to amplify a write signal to write the data or to amplify a read signal output from the head; and
a processor configured to detect a write error based on the read signal, perform a write retry operation upon detecting the write error, and store write retry information in a non-volatile memory before performing the write retry operation, wherein the write retry information comprises a location of a disk sector where the write retry operation is to be performed, and data to be written in the sector during the write retry operation.

10. The hard disk drive of claim 9, wherein the processor reads the write retry information from the non-volatile memory in response to a power on operation of the hard disk drive, and thereafter writes the data in the disk sector.

11. The hard disk drive of claim 9, wherein, in response to a power on operation of the hard disk drive, the processor determines a total number of sectors for which write retry information is stored in the non-volatile memory.

12. The hard disk drive of claim 9, wherein the processor compares a total number of sectors for which write retry information is stored in the non-volatile memory with a maximum number of sectors for which write retry information can be stored in the non-volatile memory, determines whether the total number is greater than the maximum number, and upon determining that the total number of sectors is not greater than the maximum number of sectors, stores the write retry information in the non-volatile memory.

13. The hard disk drive of claim 12, wherein the processor increments the total number of sectors upon storing the write retry information in the non-volatile memory.

14. The hard disk drive of claim 13, wherein the processor decrements the total number of sectors upon successfully completing a write retry operation.

15. The hard disk drive of claim 9, wherein the nonvolatile memory comprises a flash memory.

16. A computer system comprising:
a hard disk drive; and
a host processor configured to exchange data with the hard disk drive, wherein the hard disk drive comprises:
a magnetic recording medium configured to store data;
a spindle motor configured to rotate the magnetic recording medium;
a head configured to write the data in the magnetic recording medium or read the data from the magnetic recording medium;
a pre-amplifier configured to amplify a write signal to write the data or to amplify a read signal output from the head; and
a processor configured to detect a write error based on the read signal, perform a write retry operation upon detecting the write error, and store write retry information in a non-volatile memory before performing the write retry operation, wherein the write retry information comprises a location of a disk sector where the write retry operation is to be performed, and data to be written in the sector during the write retry operation.

17. The computer system of claim 16, wherein the processor reads the write retry information from the non-volatile memory in response to a power on operation of the hard disk drive, and thereafter writes the data in the disk sector.

18. The computer system of claim 16, wherein, in response to a power on operation of the hard disk drive, the processor determines a total number of sectors for which write retry information is stored in the non-volatile memory.

19. The computer system of claim 16, wherein the processor compares a total number of sectors for which write retry information is stored in the non-volatile memory with a maximum number of sectors for which write retry information can be stored in the non-volatile memory, determines whether the total number is greater than the maximum number, and upon determining that the total number of sectors is not greater than the maximum number of sectors, stores the write retry information in the non-volatile memory.

20. The computer system of claim 16, further comprising a wireless communication interface for wireless communication with an external computer system.
